(19) United States
(12) Patent Application Publication
(10) Pub. No.: US 2003/0077047 A1
(43) Pub. Date: Apr. 24, 2003

(54) Compact add/drop optical device

(76) Inventors: Yu-Wen Hwang, Hsinchu (TW); Chih-Wei Huang, Taichung (TW); Shih-Chiang Lin, Kaohsiung (TW)

Correspondence Address: BIRCH STEWART KOLASCH & BIRCH, PO BOX 747, FALLS CHURCH, VA, 22040-0747, US

(21) Appl. No.: 10/271,756

(22) Filed: Oct. 17, 2002

(30) Foreign Application Priority Data
Oct. 18, 2001 (TW) 90125802

(51) Int. Cl. G02B 6/38; G02B 6/36

(52) U.S. Cl. 385/79; 385/61

(57) ABSTRACT

A compact add/drop optical device. The device prevents adhesive material from blocking the light path. The compact add/drop optical device includes a first optical collimator, a second optical collimator, a filter and two spacer rings, wherein the first optical collimator has a pair of optical fibers and the second optical collimator has an optical fiber. The invention is characterized in that the filter is sandwiched between the two spacer rings. Additionally, using a heat-cured epoxy, one spacer ring adheres to the first optical collimator and the filter, and another spacer ring adheres to the second optical collimator and the filter.

### BACKGROUND OF THE INVENTION

1. Field of the Invention

The invention relates to an add/drop optical device, and more particularly to a compact add/drop optical device combining a WDM filter, a single fiber collimator and a dual fiber collimator using two spacer rings.

2. Description of the Related Art

FIG. 1 schematically shows a cross-section of a conventional add/drop optical device. As shown in FIG. 1, the conventional add/drop optical device 1 includes a first glass ferrule 2, a pair of optical fibers 3a, 3b, a first GRIN lens 4, a WDM filter 5, a second GRIN lens 6, a second glass ferrule 7, and another optical fiber 3c. The first glass ferrule 2 has a hole 2a, and grasps the pair of optical fibers 3a, 3b through the hole 2a. The end surface 2b of the first glass ferrule 2 is combined with the end surface 4a of the first GRIN lens 4 by applying a UV-curing epoxy 8 to the edges, and the WDM filter 5 adheres to another end surface 4b of the first GRIN lens 4 using a heat-cured epoxy 9. The second glass ferrule 7 has a hole 7a, and grasps the optical fiber 3c through the hole 7a. The end surface 7b of the second glass ferrule 7 is combined with the end surface 6a of the second GRIN lens 6 by the UV-curing epoxy 8 to the edges, and the WDM filter 5 adheres to another end surface 6b of the second GRIN lens 6 using the heat-cured epoxy 9.

However, the UV-curing epoxy 8 for combining the first glass ferrule 2 with the first GRIN lens 4 and combining the second glass ferrule 7 with the second GRIN lens 6 deteriorates under wet conditions. Additionally, the heat-cured epoxy 9 melts during heat-curing, and permeates the gap between the WDM filter 5 and the first GRIN lens 4, and the gap between the WDM filter 5 and the second GRIN lens 6. Thus, the heat-cured epoxy 9 blocks the light path and reduces the light intensity.

FIG. 2 schematically shows a cross-section of another conventional add/drop optical device. As shown in FIG. 2, another conventional add/drop optical device 11 disclosed by Y. Zheng has a first glass ferrule 12, a pair of optical fibers 13a, 13b, a first GRIN lens 14, a WDM filter 15, a second GRIN lens 16, a second glass ferrule 17, another optical fiber 13c, a first tube 18a, a second tube 18b and a third tube 18c. The first glass ferrule 12 has a hole 12a grasping the pair of optical fibers 13a, 13b, and is then positioned in the first tube 18a. The WDM filter 15 adheres to one end surface 14a of the first GRIN lens 14 using the heat-cured epoxy 9, and the first GRIN lens 14 with the WDM filter 15 is positioned in the second tube 18b. The first tube 18a is combined with the second tube 18b by the heat-cured epoxy 9. Furthermore, the heat-cured epoxy 9 is permeated between the first glass ferrule 12 and the inner sidewall of the first tube 18a, and permeated between the first GRIN lens 14 and the inner sidewall of the second tube 18b by capillarity effect.

The second glass ferrule 17 has a hole 17a grasping the optical fibers 13c, and the second glass ferrule 17 and the second GRIN lens 16 are then positioned in the third tube 18c. The second tube 18b is combined with the third tube 18c by the heat-cured epoxy 9. Furthermore, the heat-cured epoxy 9 is permeated between the second glass ferrule 17 and the inner sidewall of the third tube 18c, and permeated between the second GRIN lens 16 and the inner sidewall of the third tube 18c by capillarity effect.

The conventional add/drop optical device 11 uses the heat-cured epoxy to combine the optical parts, and has better resistance to wet conditions. However, the first tube 18a, second tube 18b and third tube 18c increase the weight and volume of the add/drop optical device. The heat-cured epoxy 9 easily permeates the gap 19 between the first glass ferrule and the first GRIN lens, and has the same disadvantage of blocking the light path and reducing the light intensity.

### SUMMARY OF THE INVENTION

To solve the above problems, it is an object of the present invention to provide a compact add/drop optical device having a dual fiber collimator, a single fiber collimator, a WDM filter and at least two spacer rings, wherein the spacer rings are respectively sandwiched between the dual fiber collimator and the WDM filter, and between the single fiber collimator and the WDM filter. The WDM filter and the dual fiber collimator respectively adhere to each side surface of one spacer ring using an adhesive material. The WDM filter and the single fiber collimator respectively adhere to each side surface of another spacer ring using the adhesive material.

Another object of the invention is to provide a compact add/drop optical device having a dual fiber collimator, a single fiber collimator, a WDM filter and a plurality of spacer rings. Using an adhesive material, the glass ferrule and the GRIN lens in the dual fiber collimator respectively adhere to each side surface of one spacer ring, and the filter and the GRIN lens in the single fiber collimator respectively adhere to each side surface of another spacer ring.

A feature of the invention is that two spacer rings are respectively sandwiched between the dual fiber collimator and the WDM filter, between the single fiber collimator and the WDM filter. Using the adhesive material, the WDM filter and the dual fiber collimator adhere to one spacer ring, and the WDM filter and the single fiber collimator adhere to another spacer ring.

Another feature of the invention is that a spacer ring is sandwiched between the glass ferrule and the GRIN lens in the dual fiber collimator, and using the adhesive material, the glass ferrule adheres to one side surface of the spacer ring and the GRIN lens adheres to another side surface of the spacer ring.

Another feature of the invention is that a spacer ring is sandwiched between the glass ferrule and the GRIN lens in the single fiber collimator, and using the adhesive material, the glass ferrule adheres to one side surface of the spacer ring and the GRIN lens adheres to another side surface of the spacer ring.

### BRIEF DESCRIPTION OF THE DRAWINGS

This and other objects and features of the invention will become clear from the following description, taken in conjunction with the preferred embodiments with reference to the drawings, in which:

FIG. 1 schematically shows a cross-section of a conventional add/drop optical device;

FIG. 2 schematically shows a cross-section of another conventional add/drop optical device;

FIG. 3 schematically shows a cross-section of a compact add/drop optical device according to the invention;

FIG. 4 schematically shows a spacer ring applied to the compact add/drop optical device of the invention; and

FIGS. 5A, 5B and 5C schematically show various shapes of the spacer ring applied to the compact add/drop optical device of the invention.

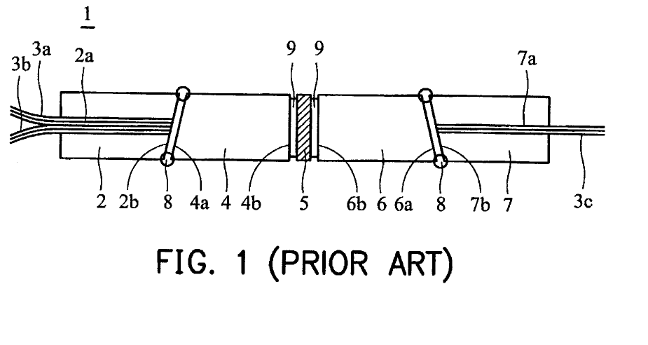

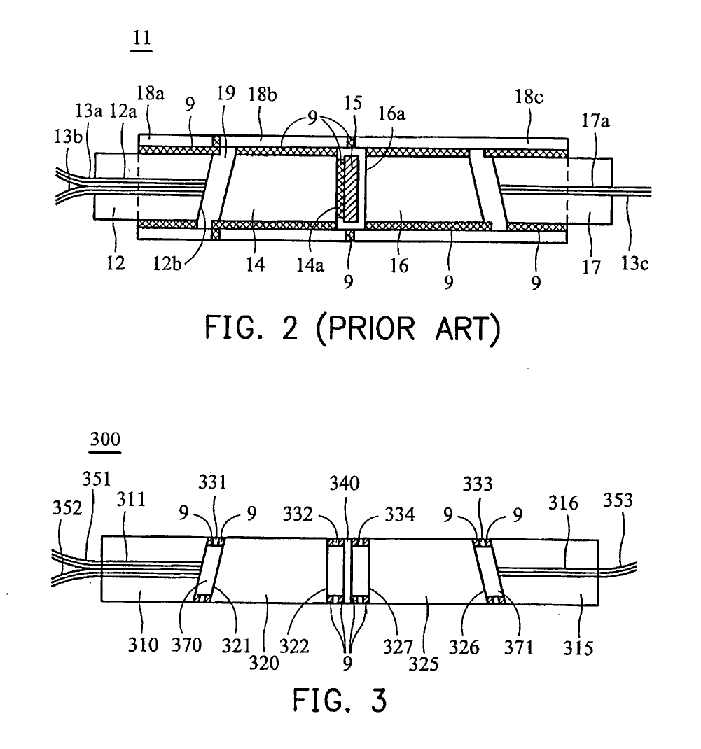

### DETAILED DESCRIPTION OF THE INVENTION

FIG. 3 schematically shows a cross-section of a compact add/drop optical device according to the invention. As shown in FIG. 3, the compact add/drop optical device 300 of the invention includes a first glass ferrule 310, a first GRIN lens 320, a first spacer ring 331, a second spacer ring 332, a WDM filter 340, a second GRIN lens 325, a second glass ferrule 315, a third spacer ring 333 and a fourth spacer ring 334. The first glass ferrule 310 has a hole 311 grasping a pair of optical fibers 351, 352. The second glass ferrule 315 has a hole 316 grasping an optical fiber 353.

The first spacer ring 331 adheres to one end surface 321 of the first GRIN lens 320 using an adhesive material, such as the heat-cured epoxy 9. The first glass ferrule 310 adheres to the first spacer ring 331 using the adhesive material 9. The first glass ferrule 310, the first GRIN lens 320, and the first spacer ring 331 construct the dual fiber collimator. The second spacer ring 332 adheres to another end surface of the first GRIN lens 320 using the adhesive material 9. The WDM filter 340 adheres to the second spacer ring 332 using the adhesive material 9. Thus, a gap 370 of predetermined size between the first glass ferrule 310 and the first GRIN lens 320 is formed.

Next, the second glass ferrule 315 has a hole 316 grasping optical fibers 353. The third spacer ring 333 adheres to one end surface 326 of the second GRIN lens 325 by the heat-cured epoxy 9 therebetween. The second glass ferrule 315 adheres to the third spacer ring 333 by the heat-cured epoxy 9. The second glass ferrule 315, the second GRIN lens 325 and the third spacer ring 333 construct the single fiber collimator. The fourth spacer ring 334 adheres to another end surface 327 of the second GRIN lens 325 by the heat-cured epoxy 9. Thus, another gap 371 of predetermined size between the second glass ferrule 315 and the second GRIN lens 325 is formed.

In the invention, the thickness of each spacer ring is 0.18 mm, the outer diameter of the spacer ring is 0.18 mm, and the inner diameter of the spacer ring is 0.12 mm. By capillarity, the heat-cured epoxy is uniformly localized therebetween. Accordingly, the invention utilizing the spacer rings ensures that the heat-cured epoxy cannot block the light path.

Before hardening the heat-cured epoxy 9 on both side surfaces of the first spacer ring 331, the dual fiber collimator is aligned by an adjusting mechanism, wherein the first GRIN lens is fixed and the first glass ferrule is precisely adjusted by a five-axis stage. A beam with broad-band is transmitted in one optical filter of the dual fiber collimator, incident on the first GRIN lens. After emitting the beam with broad-band from the first GRIN lens, the beam with broad-band is incident on the WDM filter and divided into two beams. One beam with desired wavelength passes the WDM filter, and the other is reflected from the WDM filter. The beam with desired wavelength enters the optical fiber of the single fiber collimator and is dropped from it. After obtaining the optimum intensity of the beam with desired wavelength by a detector (not shown), the five-axis stage is fixed. Next, hardening the heat-cured epoxy 9 on both side surfaces of the second spacer ring 333, the second glass ferrule, the second spacer ring and the second GRIN lens are combined tightly. Additionally, the WDM filter 340 also adheres to the fourth spacer ring 334 by the heat-cured epoxy 9, and forms the add/drop optical device of the invention.

According to the capillarity, the heat-cured epoxy is uniformly localized between the spacer ring and the GRIN lens, and between the spacer ring and the filter. Accordingly, the first embodiment ensures that the heat-cured epoxy cannot block the light path.

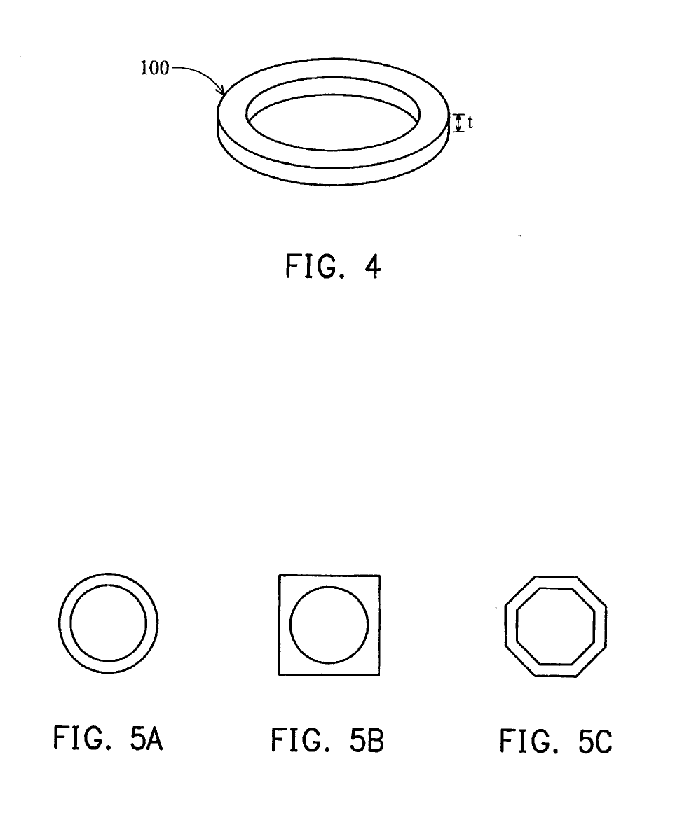

FIG. 4 schematically shows a spacer ring applied to the add/drop optical device of the invention. As shown in FIG. 4, the thickness of the spacer ring 100 is variable so as to obtain minimum transmission loss. FIG. 5 schematically shows various shapes of the spacer ring applied to the optical collimator of the invention. As shown in FIGS. 5A, 5B and 5C, the shape of spacer rings is cylindrical, rectangular or polygonal, and the pad has an opening at its center.

In the invention, the spacer ring is made of metal, glass, or immalleable material capable of sustaining 200 degrees centigrade. When the heat-cured epoxy is heated and becomes fluid, the heat-cured epoxy is uniformly localized between the spacer ring the optical part adhered to the pad by capillary. Thus, the heat-cured epoxy cannot appear in the opening of the pad to block the light path. Moreover, because of the capillarity, the spacer ring is tightly sandwiched between the filter and the GRIN lens and the invention increases the adhesion. The capillarity effect of the heat-cured epoxy poses a benefit and not a disadvantage.

While the preferred embodiment of the present invention has been described, it is to be understood that modifications will be apparent to those skilled in the art without departing from the spirit of the invention. The scope of the invention, therefore, is to be determined solely by the following claims.

What is claimed is:

1. A compact add/drop optical device comprising:
a first glass ferrule having a first hole and grasping a pair of optical fibers by the first hole;
a first GRIN lens having a first end surface and a second end surface, wherein the first end surface is combined with the first glass ferrule, and a predetermined interval is formed between the first GRIN lens and the first glass ferrule;
a second glass ferrule having a second hole and grasping an optical fiber by the second hole;
a second GRIN lens having a third end surface and a fourth end surface, wherein the third end surface is combined with the second glass ferrule, and another predetermined interval is formed between the second GRIN lens and the second glass ferrule;
a filter positioned between the second end surface of the first GRIN lens and the fourth end surface of the second GRIN lens;
a first spacer ring sandwiched between the first GRIN lens and the filter; and
a second spacer ring sandwiched between the second GRIN lens and the filter.

2. The compact add/drop optical device as claimed in claim 1, wherein the first spacer ring adheres to the first GRIN lens and the filter via heat-cured epoxy, and the second spacer ring adheres to the second GRIN lens and the filter also via heat-cured epoxy.

3. The compact add/drop optical device as claimed in claim 1, wherein, by applying a UV-curing epoxy on both edges of the first glass ferrule and the first GRIN lens, the first glass ferrule is combined with the first GRIN lens; and
by the UV-curing epoxy on both edges of the second glass ferrule and the second GRIN lens, the second glass ferrule is combined with the second GRIN lens.

4. The compact add/drop optical device as claimed in claim 1, further comprising a third spacer ring sandwiched between the first glass ferrule and the first GRIN lens.

5. The compact add/drop optical device as claimed in claim 4, wherein, using a heat-cured epoxy, the third pad adheres to the first glass ferrule and the first GRIN lens.

6. The compact add/drop optical device as claimed in claim 1, further comprising a fourth spacer ring sandwiched between the second glass ferrule and the second GRIN lens.

7. The compact add/drop optical device as claimed in claim 6, wherein, using the heat-cured epoxy, the fourth spacer ring adheres to the second glass ferrule and the second GRIN lens.

8. A compact add/drop optical device comprising:
a first glass ferrule having a first hole and grasping a pair of optical fibers by the first hole;
a first GRIN lens having a first end surface and a second end surface, wherein the first end surface is combined with the first glass ferrule, and a predetermined interval is formed between the first GRIN lens and the first glass ferrule;
a second glass ferrule having a second hole and grasping an optical fiber by the second hole;
a second GRIN lens having a third end surface and a fourth end surface, wherein the third end surface is combined with the second glass ferrule, and another predetermined interval is formed between the second GRIN lens and the second glass ferrule;
a filter positioned between the first GRIN lens and the second GRIN lens;
a first spacer ring sandwiched between the first GRIN lens and the filter;
a second spacer ring sandwiched between the second GRIN lens and the filter;
a third spacer ring sandwiched between the first GRIN lens and the first glass ferrule; and
a fourth spacer ring sandwiched between the second GRIN lens and the second glass ferrule.

9. The compact add/drop optical device as claimed in claim 8, wherein, using a heat-cured epoxy, the first spacer ring adheres to the filter and the first GRIN lens, and the second spacer ring adheres to the filter and the second GRIN lens.

10. The compact add/drop optical device as claimed in claim 8, wherein, using a heat-cured epoxy, the third spacer ring adheres to the first glass ferrule and the first GRIN lens.

11. The compact add/drop optical device as claimed in claim 8, wherein, using a heat-cured epoxy, the fourth spacer ring adheres to the second glass ferrule and the second GRIN lens.
